(19) United States
(12) Patent Application Publication
(10) Pub. No.: US 2026/0172632 A1
(43) Pub. Date: Jun. 18, 2026

(54) INTERACTIVE CONTENT PRESENTATION METHOD, APPARATUS, DEVICE, READABLE STORAGE MEDIUM, AND PRODUCT

(71) Applicant: DOUYIN VISION CO., LTD., Beijing (CN)

(72) Inventor: Yuanjun YANG, Beijing (CN)

(21) Appl. No.: 19/341,321

(22) Filed: Sep. 26, 2025

(30) Foreign Application Priority Data
Dec. 13, 2024 (CN) 202411847437.9

(51) Int. Cl. H04N 21/466; H04N 21/4788

(52) U.S. Cl. CPC H04N 21/4668; H04N 21/4788

(57) ABSTRACT

The present disclosure provide an interactive content presentation method, an apparatus, a device, a readable storage medium, and a product. The method includes: playing target media content; determining a plurality of pieces of target interactive content from all interactive media content associated with the target media content, wherein the target interactive content is configured to assist a user in performing a content consumption operation on the target media content, and the target interactive content is associated with a consumption intention of the user for the target media content; and presenting the plurality of pieces of target interactive content.

### CROSS-REFERENCE TO RELATED APPLICATIONS

The present application is based on and claims priority to China Patent Application No. 202411847437.9 filed on December 13, 2024, the disclosure of which is incorporated by reference herein in its entirety.

### TECHNICAL FIELD

Embodiments of the present disclosure relate to an interactive content presentation method, an apparatus, a device, a readable storage medium, and a product.

### BACKGROUND

When viewing media content in an application software, a user may generally publish interactive content for the media content. For example, the user may publish comments for a short drama being currently viewed. Alternatively, the user may also view the interactive content of the short drama being currently viewed according to actual needs.

### SUMMARY

In a first aspect, an embodiment of the present disclosure provides an interactive content presentation method, including: playing target media content; determining a plurality of pieces of target interactive content from all interactive media content associated with the target media content, where the target interactive content is configured to assist a user in performing a content consumption operation on the target media content, and the target interactive content is associated with a consumption intention of the user for the target media content; and presenting the plurality of pieces of target interactive content.

In a second aspect, an embodiment of the present disclosure provides an interactive content presentation apparatus, including: a playing module configured to play target media content; a determination module configured to determine a plurality of pieces of target interactive content from all interactive media content associated with the target media content, where the target interactive content is configured to assist a user in performing a content consumption operation on the target media content, and the target interactive content is associated with a consumption intention of the user for the target media content; and a presentation module configured to present the plurality of pieces of target interactive content.

In a third aspect, an embodiment of the present disclosure provides an electronic device, including: a processor and a memory; where the memory stores a computer-executable instruction; and the processor executes the computer-executable instruction stored in the memory, to cause the at least one processor to execute the interactive content presentation method according to the above first aspect and various possible designs of the first aspect.

In a fourth aspect, an embodiment of the present disclosure provides a computer-readable storage medium, where the computer-readable storage medium stores a computer-executable instruction, and when a processor executes the computer-executable instruction, the interactive content presentation method according to the above first aspect and various possible designs of the first aspect is implemented.

In a fifth aspect, an embodiment of the present disclosure provides a computer program product, including a computer program, where when the computer program is executed by a processor, the interactive content presentation method according to the above first aspect and various possible designs of the first aspect is implemented.

### BRIEF DESCRIPTION OF THE DRAWINGS

In order to illustrate the technical solutions in the embodiments of the present disclosure or in the prior art more clearly, the drawings required in describing the embodiments or the prior art will be briefly introduced below. Apparently, the drawings in the following description are only some embodiments of the present disclosure, and for those of ordinary skill in the art, other drawings may also be obtained according to these drawings without paying any creative effort.

FIG. 1 is a schematic flowchart of an interactive content presentation method provided by an embodiment of the present disclosure;

FIG. 2 is a schematic flowchart of an interactive content presentation method provided by another embodiment of the present disclosure;

FIG. 3 is a schematic flowchart of an interactive content presentation method provided by another embodiment of the present disclosure;

FIG. 4 is a schematic flowchart of an interactive content presentation method provided by another embodiment of the present disclosure;

FIG. 5 is a schematic flowchart of an interactive content presentation method provided by another embodiment of the present disclosure;

FIG. 6 is a schematic diagram of a display interface provided by an embodiment of the present disclosure;

FIG. 7 is a schematic structural diagram of an interactive content presentation apparatus provided by an embodiment of the present disclosure; and

FIG. 8 is a schematic structural diagram of an electronic device provided by an embodiment of the present disclosure.

### DETAILED DESCRIPTION

In order to make the objectives, technical solutions, and advantages of embodiments of the present disclosure clearer, the technical solutions in the embodiments of the present disclosure will be described clearly and comprehensively with reference to the drawings in the embodiments of the present disclosure. Apparently, the described embodiments are only some of the embodiments of the present disclosure, rather than all of them. All other embodiments obtained by those of ordinary skill in the art based on the embodiments of the present disclosure without paying any creative effort shall fall within the protection scope of the present disclosure.

It may be understood that before the technical solutions disclosed in the embodiments of the present disclosure are used, the user shall be informed of the type, range of use, use scenarios, etc., of personal information involved in the present disclosure in an appropriate manner and obtain the authorization of the user in accordance with relevant laws and regulations.

For example, in response to receiving an active request from a user, a prompt message is sent to the user to clearly inform the user that the requested operation will need to access and use the user's personal information. In this way, the user may independently choose, based on the prompt message, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt message may be sent to the user in the form of, for example, a pop-up window, in which the prompt message may be presented in text. In addition, the pop-up window may also include a selection control for the user to choose whether to "agree" or "disagree" to provide the personal information to the electronic device.

It may be understood that the above process of notifying and obtaining user authorization is only illustrative and does not limit the implementations of the present disclosure, and other manners that satisfy relevant laws and regulations may also be applied to the implementations of the present disclosure.

In the related art, the interactive content is generally presented according to parameters such as the number of likes and the publication time of each piece of interactive content. However, presenting the interactive content in the above manner often leads to relatively single presentation content and poor content quality, failing to meet the needs of users.

In view of this, the present disclosure provides an interactive content presentation method, an apparatus, a device, a readable storage medium, and a product.

It should be noted that the interactive content presentation method, the apparatus, the device, the readable storage medium, and the product provided by the present disclosure may be applied to any interactive content presentation scenario.

In the related art, the interactive media content associated with the target media content is generally presented in a descending order of the amount of interaction, or in a chronological or reverse chronological order of the release time. However, presenting the interactive content in the above manner often leads to relatively single presentation content and poor quality of the presentation content.

Through research, the inventor has found that when browsing media content, a user has different consumption needs for different playback progress. For example, in the process of browsing a short drama, a user's consumption needs for the comment content associated with the first episode, the last episode, and the middle episode(s) are different. When browsing the first episode, the user may be more inclined to browse comment content that recommends the content of the short drama, when browsing the middle episode(s), the user may be more inclined to browse comment content that discusses the plot, and when browsing the last episode, the user is about to face a situation of "shortage of dramas", and thus may be more inclined to browse comment content that recommends other media content.

Therefore, when the target media content is played, the target interactive content that better meets the user's current consumption needs may be determined from all interactive media content associated with the target media content. The plurality of pieces of target interactive content are presented to assist the user in content consumption based on the target interactive content.

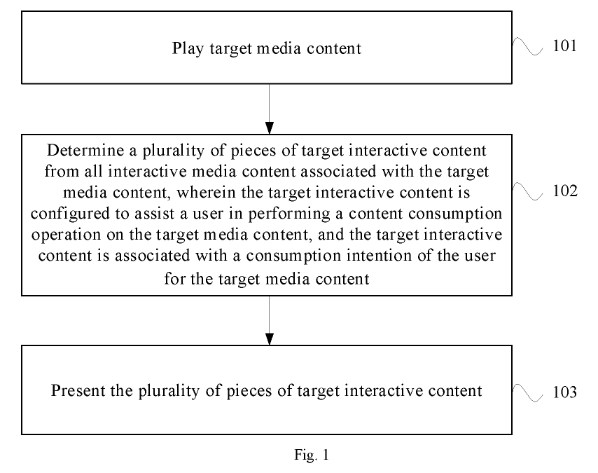

FIG. 1 is a schematic flowchart of an interactive content presentation method provided by an embodiment of the present disclosure. As shown in FIG. 1, the method includes the following steps.

In step 101, target media content is played.

In step 102, a plurality of pieces of target interactive content are determined from all interactive media content associated with the target media content, where the target interactive content is configured to assist a user in performing a content consumption operation on the target media content, and the target interactive content is associated with a consumption intention of the user for the target media content.

In step 103, the plurality of pieces of target interactive content are presented.

The execution body of this embodiment is an interactive content presentation apparatus, which may be coupled to a terminal device. Therefore, the interactive content presentation apparatus may present interactive content based on a trigger operation of a user on the terminal device.

In this embodiment, the user may browse the target media content on the terminal device. When browsing the media content, each user may publish interactive content for the target media content, where the interactive content includes a text content, an image content, a voice content, a bullet screen, etc., posted by the user for the target media content.

When browsing the target media content, the user may have different feelings and consumption intentions for different playback progress. Therefore, in order to make the presented interactive media content more in line with the user's current consumption intention, a plurality of pieces of target interactive content that match the user's current consumption intention may be selected from all the interactive media content associated with the target media content. The plurality of pieces of target interactive content are presented to assist the user in performing the content consumption operation on the target media content based on the plurality of pieces of target interactive content.

In some embodiments, the target media content is any piece of multimedia content in a preset multimedia content set, where a plurality of pieces of multimedia content in the multimedia content set have content continuity; and the user has different consumption intentions for multimedia content at different playback progress in the multimedia content set.

The target media content is any piece of multimedia content in a preset multimedia content set. The multimedia content set may be a full set of TV dramas, a full set of short dramas, etc. The plurality of pieces of multimedia content in the multimedia content set have content continuity.

Taking a practical application as an example, the multimedia content set may be a short drama set. The short drama media content includes a plurality of short videos whose duration is less than a preset duration threshold. The plurality of short videos in the short drama set have content continuity.

The user has different consumption intentions for the multimedia content at different playback progress in the multimedia content set.

In some embodiments, the target media content is preset video media content; and the user has different consumption intentions for presentation content at different playback progress in the video media content.

For example, the target media content may be media content such as a movie or a variety show. The user also has different consumption intentions when browsing the presentation content of different playback progress.

For example, the target media content may be one episode of short drama in a short drama set. When the user watches the first episode of the short drama media content, the user may be more curious about the style or plot of the short drama, and thus may have a greater need to view more comment content about recommendation or "Amway" in the comment area, that is, the user's consumption intention for the first episode of media content is a content recommendation intention. When the user watches an intermediate episode of the short drama media content, the user may have a greater need to discuss the plot with other users in the comment area, and thus may have a greater need to browse more interactive content of the plot discussion type in the comment area, that is, the user's consumption intention for the intermediate part of the media content is a plot discussion intention. When the user watches the last episode of the short drama media content, the user has finished watching the current short drama and is about to face the problem of "shortage of dramas", and thus may want to browse more recommendation comments for other episodes, recommendation comments for other episodes starring the actors of the short drama being currently browsed, etc., in the comment area, that is, the user's consumption intention for the last episode of media content is an extended consumption intention.

According to the interactive content presentation method provided by this embodiment, when the target media content is played, a plurality of pieces of target interactive content related to the consumption intention of the user for the target media content are determined from all interactive media content corresponding to the target media content, and the plurality of pieces of target interactive content are presented. Therefore, when the target media content is played, the target interactive content more in line with the consumption intention of the user may be presented, so that the user may browse the interactive media content related to the current consumption intention more intuitively while browsing the target media content.

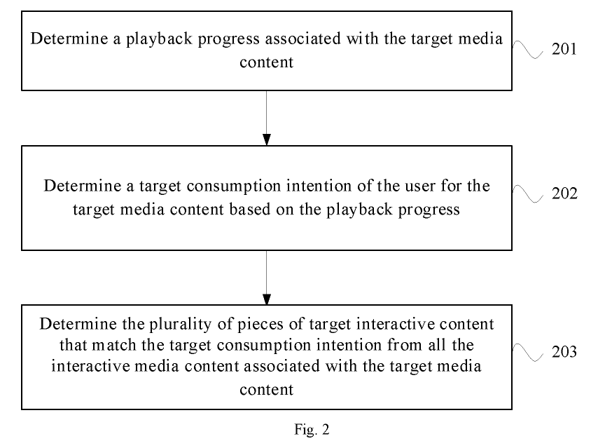

FIG. 2 is a schematic flowchart of an interactive content presentation method provided by another embodiment of the present disclosure. Based on any of the above embodiments, as shown in FIG. 2, step 102 includes the following steps.

In some embodiments, based on any of the above embodiments, the target media content is short drama media content, and the short drama media content includes a plurality of pieces of video media content whose duration is less than a preset duration threshold.

In step 201, a playback progress associated with the target media content is determined.

In step 202, a target consumption intention of the user for the target media content is determined based on the playback progress.

In step 203, a plurality of pieces of target interactive content that match the target consumption intention are determined from all the interactive media content associated with the target media content.

In this embodiment, when browsing the target media content, the user may have different feelings and consumption intentions for different playback progress. Therefore, in order to more accurately determine the plurality of pieces of target interactive content to be currently presented, the playback progress associated with the target media content may be determined.

When the target media content is any piece of multimedia content in the multimedia content set, the playback progress associated with the target media content may be the episode number corresponding to the target media content. Alternatively, the playback progress associated with the target media content may be the episode number associated with the target media content and the current playback duration. When the target media content is the preset video media content, the playback progress may be the current playback duration.

Further, the user has different consumption needs for the interactive media content for different playback progress. For example, when the target media content is any piece of multimedia content in the multimedia content set, if the target media content is the first episode of media content, the user may be more inclined to browse comment content that recommends the content of the short drama. If the target media content is the intermediate part of the media content, the user may be more inclined to browse comment content that discusses the plot. If the target media content is the last episode of media content, the user is about to face a situation of "shortage of dramas", and thus may be more inclined to browse comment content that recommends other media content. Therefore, after the current playback progress is determined, the target consumption intention of the user for the target media content may be determined based on the playback progress. Therefore, the plurality of pieces of target interactive content that match the target consumption intention may be determined from all the interactive media content associated with the target media content.

According to the interactive content presentation method provided by this embodiment, the target consumption intention is determined based on the playback progress associated with the target media content, so that the filtering operation may be performed on all the interactive media content associated with the target media content based on the target consumption intention, and a plurality of pieces of target interactive content that match the target consumption intention may be presented. Therefore, more diversified target interactive content may be presented for different playback progress, so that the presented target interactive content is more in line with the user's consumption intention for the interactive media content.

In some embodiments, based on any of the above embodiments, step 202 includes the following steps.

In response to the playback progress being within a preset first progress interval, a content recommendation intention for the multimedia content set is determined as the target consumption intention.

In response to the playback progress being within a preset second progress interval, a plot discussion intention for the target media content is determined as the target consumption intention.

In response to the playback progress being within a preset third progress interval, an intention to perform extended consumption based on the multimedia content set is determined as the target consumption intention.

The third progress interval is greater than the second progress interval, and the second progress interval is greater than the first progress interval.

In this embodiment, when the user browses the target media content, the user’s consumption needs for the interactive content may be different for different playback progress. Therefore, a plurality of progress intervals may be set in advance, and each progress interval corresponds to a different consumption intention. Therefore, after the current playback progress is determined, the progress interval that matches the playback progress may be determined, and the consumption intention corresponding to the progress interval may be determined as the current target consumption intention.

In some embodiments, a first progress interval, a second progress interval, and a third progress interval may be set in advance, where the third progress interval is greater than the second progress interval, and the second progress interval is greater than the first progress interval. For example, when the target media content is video media content, the first progress interval may be the first 10% of the video media content, the second progress interval may be 11% to 90% of the video media content, and the third progress interval may be 91% to 100% of the video media content. When the target media content is any piece of multimedia content in the multimedia content set, the first progress interval may be before the second episode, the third progress interval may be after the second-to-last episode, and the second progress interval may be between the first episode and the last episode.

Further, in response to the playback progress being within the preset first progress interval, the content recommendation intention for the multimedia content set is determined as the target consumption intention.

Taking a practical application as an example, when the target media content is any piece of multimedia content in the short drama media content set, if it is determined that the current playback progress of the target media content is within the first progress interval, for example, the target media content is the first episode of media content in the short drama media content set, when the user watches the target media content, the user may be more curious about the style or plot of the short drama, and thus may have a greater need to view more comment content about recommendation or "Amway" in the comment area. Therefore, the content recommendation intention for the multimedia content set may be determined as the target consumption intention.

In response to the playback progress being within the preset second progress interval, the plot discussion intention for the target media content is determined as the target consumption intention.

Continuing with the above example, if it is determined that the playback progress associated with the target media content is within the second progress interval, that is, the target media content is an intermediate episode in the short drama media content set, when the user watches the intermediate episode of the short drama media content, the user may have a greater need to discuss the plot with other users in the comment area, and thus the plot discussion intention for the target media content may be determined as the target consumption intention.

In response to the playback progress being within the preset third progress interval, the intention to perform extended consumption based on the multimedia content set is determined as the target consumption intention.

Still continuing with the above example, if the playback progress associated with the target media content falls within the third progress interval, for example, the target media content is the last episode in the short drama media content set, the user has finished watching the current short drama and is about to face the problem of "shortage of dramas", and thus may want to browse more recommendation comments for other episodes, recommendation comments for other episodes starring the actors of the short drama being currently browsed, etc., in the comment area. Therefore, the intention to perform extended consumption based on the multimedia content set may be determined as the target consumption intention.

According to the interactive content presentation method provided by this embodiment, the progress interval corresponding to the playback progress is determined, and the consumption intention associated with the progress interval is determined as the target consumption intention, so that different interactive content may be presented for different playback progress. Therefore, the presented target interactive content is more in line with the user's current consumption intention, and the content quality of the target interactive content is improved.

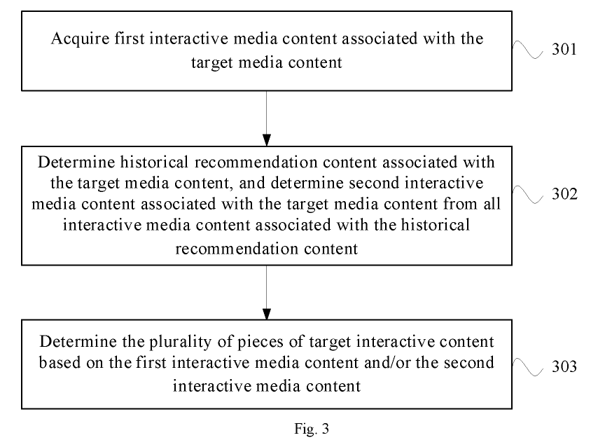

FIG. 3 is a schematic flowchart of an interactive content presentation method provided by another embodiment of the present disclosure. Based on any of the above embodiments, as shown in FIG. 3, step 103 includes the following steps.

In step 301, first interactive media content associated with the target media content is acquired, the first interactive media content including interactive media content posted by a plurality of users historically for the target interactive content.

In step 302, historical recommendation content associated with the target media content is determined, and second interactive media content associated with the target media content is determined from all interactive media content associated with the historical recommendation content.

In step 303, the plurality of pieces of target interactive content are determined based on the first interactive media content and/or the second interactive media content.

In this embodiment, in order to present the target interactive content more in line with the current target consumption intention, it is first necessary to acquire all interactive media content associated with the target media content.

In some embodiments, the first interactive media content associated with the target media content may be acquired, where the first interactive media content is historically generated and posted by other audiences based on the target media content. For example, the first interactive media content may be comment text content, image comment content, audio comment content, etc., posted by other users when the other users watch the video media content.

In addition, the target media content may also be associated with historical recommendation content. For example, any user may publish recommendation information for recommending the target media content under a preset topic. Alternatively, any user may publish recommendation information such as a film review based on the target media content. Therefore, the second interactive media content associated with the target media content may also be determined from all the interactive media content associated with the historical recommendation content.

Therefore, the plurality of pieces of target interactive content may be determined based on more comprehensive first interactive media content and/or second interactive media content.

According to the interactive content presentation method provided by this embodiment, the first interactive media content and/or the second interactive media content are acquired separately, so that the filtering operation of the target interactive content may be performed based on more comprehensive interactive media content, and the content quality of the target interactive content may be improved.

Further, based on any of the above embodiments, step 303 includes: determining a target network model associated with the target consumption intention; and inputting the first interactive media content and/or the second interactive media content into the target network model, and determining the plurality of pieces of target interactive content based on an output result of the target network model.

In this embodiment, in order to accurately identify the target interactive content of different consumption intentions, different network models may be trained in advance for different consumption intentions.

Therefore, after the target consumption intention of the user for the target media content is determined, the target network model that matches the target consumption intention may be determined. A plurality of pieces of target interactive content that match the target consumption intention are determined from the first interactive media content and/or the second interactive media content associated with the target media content by using the target network model.

According to the interactive content presentation method provided by this embodiment, different network models are trained in advance for different target consumption intentions, so that after the target consumption intention is determined, an identification operation may be performed on the first interactive media content and/or the second interactive media content associated with the currently played video media content based on the target network model associated with the target consumption intention, to implement the filtering operation of the target interactive content that matches the target consumption intention. Therefore, the presented target interactive content is more in line with the user's consumption intention.

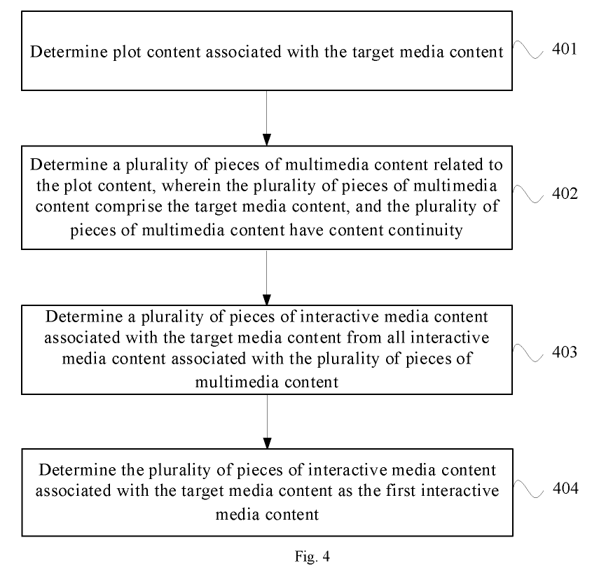

FIG. 4 is a schematic flowchart of an interactive content presentation method provided by another embodiment of the present disclosure. Based on any of the above embodiments, the target media content is any piece of multimedia content in a preset multimedia content set. As shown in FIG. 4, step 301 includes the following steps.

In step 401, plot content associated with the target media content is determined.

In step 402, a plurality of pieces of multimedia content related to the plot content are determined, the plurality of pieces of multimedia content including the target media content, and the plurality of pieces of multimedia content having content continuity.

In step 403, a plurality of pieces of interactive media content associated with the target media content are determined from all interactive media content associated with the plurality of pieces of multimedia content.

In step 404, the plurality of pieces of interactive media content associated with the target media content are determined as the first interactive media content.

In this embodiment, the target media content is any piece of multimedia content in the preset multimedia content set. In the multimedia content set, a plurality of pieces of multimedia content may be associated with the same plot content. Therefore, the plurality of pieces of multimedia content may all be associated with interactive media content related to the plot content.

Therefore, in order to acquire more comprehensive and accurate first interactive media content, the plot content associated with the target media content may be determined. The plot content associated with the target media content may be identified by a preset identification algorithm, or the plot content associated with the target media content may be determined based on the current playback progress of the target media content and preset plot summary content, which is not limited by the present disclosure.

The plurality of pieces of multimedia content related to the plot content are determined, the plurality of pieces of multimedia content including the target media content, and the plurality of pieces of multimedia content having content continuity. All interactive media content associated with the plurality of pieces of multimedia content are acquired. The plurality of pieces of interactive media content associated with the target media content are determined from all the interactive media content. Plot details corresponding to the target media content may be specifically determined, and a plurality of pieces of interactive media content that match the plot details are determined from all the interactive media content. Therefore, the plurality of pieces of interactive media content associated with the target media content may be determined as the first interactive media content.

As an implementable manner, when the target media content includes a plurality of pieces of plot content, the target plot content currently being played may be determined based on the playback progress. A plurality of pieces of interactive media content, as the first interactive media content, that match the target plot content currently being played are selected from all media content associated with the target media content.

According to the interactive content presentation method provided by this embodiment, the first interactive media content is acquired with the plot content as a dimension, so that more comprehensive first interactive media content may be acquired. Therefore, the target interactive content more in line with the actual consumption intention of the user may be generated based on the first interactive media content.

In some embodiments, based on any of the above embodiments, step 102 includes: acquiring the plurality of pieces of target interactive content associated with the target media content from a preset storage path.

The plurality of pieces of target interactive content are obtained by the server determining a target consumption intention corresponding to the target media content based on a playback progress associated with the target media content, and performing data processing on all interactive media content corresponding to the target media content using a target network model associated with the target consumption intention, and the plurality of pieces of target interactive content are stored into the storage path after a mapping relationship between the plurality of pieces of target interactive content and the target media content is established.

In this embodiment, in order to accurately identify the target interactive content corresponding to different consumption intentions, the server may train different network models for different consumption intentions in advance. Therefore, for each piece of target media content, after the consumption intention associated with the each piece of target media content is determined, a plurality of pieces of target interactive content that match the consumption intention are determined from all interactive content associated with the target media content by using a target network model associated with the consumption intention.

In addition, in order to improve the presentation efficiency of interactive content in the client, a mapping relationship between the video media content and the plurality of pieces of target interactive content may also be established, and the plurality of pieces of interactive content may be stored into a preset storage path.

Thus, when the user browses the target media content in the client, the plurality of pieces of target interactive content that are associated with the target media content and match the consumption intention may be directly acquired from the storage path.

According to the interactive content presentation method provided by this embodiment, the consumption intention associated with the video media content is determined in advance based on the playback progress associated with each piece of target media content, and then a network model that matches the consumption intention may be invoked to perform a filtering operation on all interactive content associated with the target media content, to obtain a plurality of pieces of target interactive content. The plurality of pieces of target interactive content are stored in the preset storage path in advance, so that when the interactive content is viewed at the client, the plurality of pieces of target interactive content may be directly acquired from the storage path for presentation. Therefore, the presentation efficiency of the interactive content may be improved on the basis that the plurality of pieces of presented target interactive content are more in line with the current consumption intention.

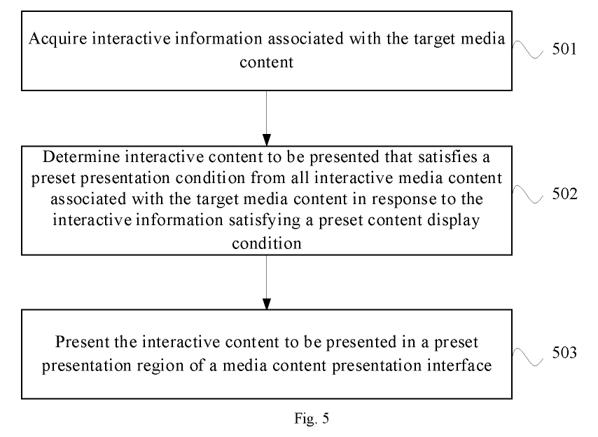

FIG. 5 is a schematic flowchart of an interactive content presentation method provided by another embodiment of the present disclosure. Based on any of the above embodiments, as shown in FIG. 5, the method further includes the following steps.

In step 501, interactive information associated with the target media content is acquired, the interactive information including one or more of: the number of pieces of interactive media content, the number of likes, and the number of plays.

In step 502, interactive content to be presented that satisfies a preset presentation condition is determined from all interactive media content associated with the target media content in response to the interactive information satisfying a preset content display condition.

In step 503, the interactive content to be presented is presented in a preset presentation region of a media content presentation interface.

In this embodiment, for the multimedia content with less interactive content and low popularity in the multimedia content set, high-quality comments associated with the multimedia content may be displayed, so that the user may more intuitively browse the high-quality comments.

For the target media content currently being played, its associated interactive parameters may be determined, the interactive parameters including one or more of: the number of pieces of interactive content, the number of likes, and the number of plays. It is determined whether the target media content satisfies a preset interactive content display condition based on the interactive parameters. The interactive content display condition may be that the number of pieces of interactive content and/or the number of likes and/or the number of plays is less than a preset number threshold, which is not limited by the present disclosure.

Further, if the interactive parameters satisfy the preset interactive content display condition, the interactive content to be presented that satisfies the preset presentation condition is determined from all interactive content associated with the target media content. The interactive content with the most likes/most comments in all the interactive content may be determined as the interactive content to be presented.

Therefore, the interactive content to be presented may be presented in the preset presentation region of the media content presentation interface. For example, in order to avoid occluding the video media content, the interactive content to be presented may be presented at the bottom of the media content presentation interface.

According to the interactive content presentation method provided by this embodiment, when the popularity of the target media content currently being played is not high, the interactive content to be presented that satisfies the preset presentation condition is displayed, so that the user may more intuitively view the interactive content to be presented when browsing the video media content in the media content presentation interface, improving the user experience. In addition, by displaying the interactive content to be presented that satisfies the preset presentation condition, the user may more conveniently trigger the view operation of other interactive content.

In some embodiments, based on any of the above embodiments, step 102 includes: determining the plurality of pieces of target interactive content from all the interactive media content associated with the target media content in response to a trigger operation of the user on a preset interactive control in the media content presentation interface.

In this embodiment, in the process of playing the target media content, the target interactive content may be presented based on the trigger operation of the user on the preset interactive control in the media content presentation interface.

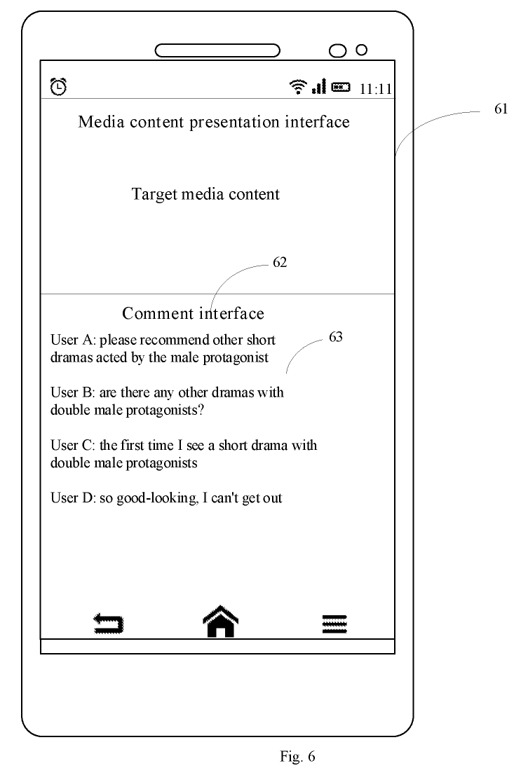

FIG. 6 is a schematic diagram of a display interface provided by an embodiment of the present disclosure. As shown in FIG. 6, after the user performs the trigger operation on the preset interactive control in the media content presentation interface 61, the comment interface 62 may be presented in the media content presentation interface 61. For example, when the target media content currently being played is the last episode content in the multimedia content set, a plurality of pieces of target interactive content 63 for mining other episodes and actor information may be presented in the comment interface.

In some embodiments, based on any of the above embodiments, the method further includes: acquiring a multimedia content set, the multimedia content set including a plurality of pieces of multimedia content having plot continuity; determining, for each piece of multimedia content, a playback progress associated with the multimedia content, and determining a target consumption intention corresponding to the multimedia content based on the playback progress; determining a plurality of pieces of target interactive content that match the target consumption intention from all interactive media content associated with the multimedia content using a target network model associated with the target consumption intention; and establishing a mapping relationship between the multimedia content and the plurality of pieces of target interactive content, and storing the plurality of pieces of interactive content into a preset storage path.

The execution body of this embodiment is an interactive content presentation apparatus, which may be coupled to a server. The server may be communicatively connected to a data server.

In this embodiment, the user may browse the multimedia content set on the terminal device. The multimedia content set includes a plurality of pieces of multimedia content having plot continuity. In addition, the plurality of pieces of multimedia content have content continuity.

In order to enable the user to browse interactive content of different consumption intentions in the comment areas of different episodes when browsing the multimedia content set, the filtering operation of the target interactive content may first be performed for each piece of multimedia content in the multimedia content set.

In some embodiments, the multimedia content set may be acquired, and the playback progress associated with the multimedia content may be determined for each piece of multimedia content. The playback progress may be the episode number of the multimedia content in the multimedia content set. For example, if the playback progress associated with the multimedia content is 5, it represents that the multimedia content is the fifth episode, that is, an intermediate episode, in the multimedia content set.

Further, when the user browses the multimedia content set, the user may browse the interactive media content associated with the multimedia content set. The interactive media content may be comment text, comment images, etc. historically posted by other users for the short drama. In practical applications, the user's consumption intentions for the interactive media content may be different for multimedia content of different episode numbers.

For example, the user's consumption needs for the comment content associated with the first episode, the last episode, and the intermediate episodes are different when browsing the short drama. When browsing the first episode, the user may be more inclined to browse comment content that recommends the content of the short drama. When browsing the intermediate episode, the user may be more inclined to browse comment content that discusses the plot. When browsing the last episode, the user is about to face a situation of "shortage of dramas", and thus may be more inclined to browse comment content that recommends other media content.

Therefore, in order to present different comment content for different episodes, the target consumption intention corresponding to the multimedia content may be determined based on the playback progress. The target consumption intention includes a content recommendation intention, a plot discussion intention, extended consumption, etc.

In order to accurately identify the target interactive content of different consumption intentions, different network models may be trained for different consumption intentions in advance. Therefore, for each piece of multimedia content, after its associated consumption intention is determined, a plurality of pieces of target interactive content that match the consumption intention are determined from all interactive content associated with the multimedia content by using a target network model associated with the consumption intention.

In addition, in order to improve the presentation efficiency of interactive content in the client, a mapping relationship between the video media content and the plurality of pieces of target interactive content may also be established, and the plurality of pieces of interactive content may be stored into a preset storage path. Thus, when the interactive content is viewed at the client, the plurality of pieces of target interactive content may be directly acquired from the storage path for presentation.

According to the interactive content presentation method provided by this embodiment, the consumption intention associated with the multimedia content is determined in advance based on the playback progress associated with each piece of multimedia content, and then the target network model that matches the consumption intention may be invoked to perform a filtering operation on all interactive content associated with the multimedia content, to obtain a plurality of pieces of target interactive content. The plurality of pieces of target interactive content are stored in the preset storage path in advance, so that when the interactive content is viewed at the client, the plurality of pieces of target interactive content may be directly acquired from the storage path for presentation. Therefore, the presentation efficiency of the interactive content may be improved on the basis that the plurality of pieces of presented target interactive content are more in line with the user's consumption intention.

In some embodiments, based on any of the above embodiments, the consumption intention includes a content recommendation intention. The method further includes: acquiring a preset first training dataset, the first training dataset including a plurality of first training data pairs, the first training data pair including a plurality of pieces of interactive media content associated with a preset video media content and labeled content, and the labeled content being at least one piece of recommendation interactive media content for the preset video media content in the plurality of pieces of interactive media content; and performing iterative training on a preset to-be-trained model using the first training dataset until the to-be-trained model satisfies a preset convergence condition, to obtain the target network model corresponding to the episode recommendation type.

In this embodiment, in order to enable the target network model to select target interactive content that matches the content recommendation intention from all interactive content associated with the multimedia content, it is first necessary to train the target network model corresponding to the content recommendation intention.

In some embodiments, a preset first training dataset may be acquired, where the first training dataset includes a plurality of first training data pairs, the first training data pair includes a plurality of pieces of interactive media content associated with a preset video media content and labeled content, and the labeled content is at least one piece of recommendation interactive media content for the preset video media content in the plurality of pieces of interactive media content.

By setting the first training dataset, the target network model that converges based on the training of the first training dataset may identify, from all interactive content corresponding to the video media content, the target interactive content that matches the content recommendation intention.

For example, the recommendation interactive media content may be a recommendation comment for the short drama media content. Therefore, comments that recommend the current short drama may be selected from all the comment texts. For example, the recommendation interactive media content may be "good-looking! wonderful!", "everyone is pleasing to the eye", "a high-quality drama with texture", "a visual experience of a big movie", etc.

Further, after the first training dataset is acquired, the first training data pair may be input into a preset to-be-trained model, to obtain a plurality of pieces of interactive content that match the content recommendation intention and that are identified by the to-be-trained model in the plurality of pieces of interactive media content associated with the preset video media content. Thus, a loss value of the to-be-trained model may be calculated based on an output result of the to-be-trained model and the labeled content. Any loss algorithm may be used to calculate the loss value of the to-be-trained model, which is not limited by the present disclosure.

Therefore, whether the to-be-trained model satisfies a preset convergence condition may be determined based on the loss value. The convergence condition may be that the loss value is less than a preset loss value threshold, or the convergence condition may be that a difference between loss values in two consecutive rounds of training is less than a preset difference threshold. As an implementable manner, the convergence condition may also be that the training duration reaches a preset duration threshold, the number of training rounds reaches a preset number threshold, etc., which is not limited by the present disclosure.

Further, if it is determined that the to-be-trained model satisfies the preset convergence condition, the current to-be-trained model may be determined as the target network model corresponding to the content recommendation intention. Otherwise, a parameter adjustment operation may be performed on the to-be-trained model based on the loss value. After the adjustment, the iterative training continues to be performed based on the first training dataset until the to-be-trained model satisfies the preset convergence condition, and the current to-be-trained model is determined as the target network model corresponding to the content recommendation intention.

In some embodiments, based on any of the above embodiments, the consumption intention includes a plot discussion intention. The method further includes: acquiring a preset second training dataset, the second training dataset including a plurality of second training data pairs, the second training data pair including a plurality of pieces of interactive media content associated with a preset video media content and labeled content, and the labeled content being at least one piece of interactive media content with a reply rate greater than a preset probability threshold and content quality satisfying a preset condition in the plurality of pieces of interactive media content; and performing iterative training on a preset to-be-trained model using the second training dataset until the to-be-trained model satisfies a preset convergence condition, to obtain the target network model corresponding to the plot discussion intention.

In this embodiment, in order to enable the target network model to select target interactive content that matches the plot discussion intention from all interactive content associated with the video media content, it is first necessary to train the target network model corresponding to the plot discussion intention.

In some embodiments, a preset second training dataset may be acquired, where the second training dataset includes a plurality of second training data pairs, the second training data pair includes a plurality of pieces of interactive media content associated with a preset video media content and labeled content, and the labeled content is at least one piece of interactive media content with a reply rate greater than a preset probability threshold and content quality satisfying a preset condition in the plurality of pieces of interactive media content.

By setting the second training dataset, the target network model that converges based on the training of the second training dataset may identify, from all interactive content corresponding to the video media content, the target interactive content that matches the plot discussion intention.

For example, the interactive media content may be a discussion comment for the short drama media content. Therefore, interactive content of comments for the current short drama may be selected from all the comment texts. For example, the recommendation interactive media content may be "chasing the wife to the crematorium", "the car is fully responsible", "finally there are more realistic three views", "the plot is too abusive", etc.

Further, after the first training dataset is acquired, the first training data pair may be input into a preset to-be-trained model, to obtain a plurality of pieces of interactive content that match the plot discussion intention and that are identified by the to-be-trained model in the plurality of pieces of interactive media content associated with the preset video media content. Thus, a loss value of the to-be-trained model may be calculated based on an output result of the to-be-trained model and the labeled content. Any loss algorithm may be used to calculate the loss value of the to-be-trained model, which is not limited by the present disclosure.

Therefore, whether the to-be-trained model satisfies a preset convergence condition may be determined based on the loss value. The convergence condition may be that the loss value is less than a preset loss value threshold, or the convergence condition may be that a difference between loss values in two consecutive rounds of training is less than a preset difference threshold. As an implementable manner, the convergence condition may also be that the training duration reaches a preset duration threshold, the number of training rounds reaches a preset number threshold, etc., which is not limited by the present disclosure.

Further, if it is determined that the to-be-trained model satisfies the preset convergence condition, the current to-be-trained model may be determined as the target network model corresponding to the plot discussion intention. Otherwise, a parameter adjustment operation may be performed on the to-be-trained model based on the loss value. After the adjustment, the iterative training continues to be performed based on the first training dataset until the to-be-trained model satisfies the preset convergence condition, and the current to-be-trained model is determined as the target network model corresponding to the plot discussion intention.

In some embodiments, based on any of the above embodiments, the consumption intention includes an extended consumption intention. Before step 503, the method further includes: acquiring a preset third training dataset, the third training dataset including a plurality of third training data pairs, the third training data pair including a plurality of pieces of interactive media content associated with a preset video media content and labeled content, and the labeled content being at least one piece of interactive media content for recommending an actor associated with the preset video media content and/or recommending other media content in the plurality of pieces of interactive media content; and performing iterative training on a preset to-be-trained model using the third training dataset until the to-be-trained model satisfies a preset convergence condition, to obtain the target network model corresponding to the extended consumption intention.

In this embodiment, in order to enable the target network model to select target interactive content that matches the extended consumption intention from all interactive content associated with the video media content, it is first necessary to train the target network model corresponding to the extended consumption intention.

In some embodiments, a preset third training dataset may be acquired, where the third training dataset includes a plurality of third training data pairs, the third training data pair includes a plurality of pieces of interactive media content associated with a preset video media content and labeled content, and the labeled content is at least one piece of interactive media content for recommending an actor associated with the preset video media content and/or recommending other media content in the plurality of pieces of interactive media content.

By setting the third training dataset, the target network model that converges based on the training of the third training dataset may identify, from all interactive content corresponding to the video media content, the target interactive content that matches the extended consumption intention.

For example, the interactive media content may be a comment that recommends the actor associated with the preset video media content and/or recommends other media content. Therefore, comments that recommend the actor associated with the preset video media content and/or recommend other media content may be selected from all the comment texts. For example, the interactive media content may be "are there any other dramas with double male protagonists recommended?", "are there any similar short dramas?", "please recommend other dramas acted by the protagonist", "short drama A is similar to this short drama, strongly recommended", etc.

Further, after the third training dataset is acquired, the third training data pair may be input into a preset to-be-trained model, to obtain a plurality of pieces of interactive content that match the extended consumption intention and that are identified by the to-be-trained model in the plurality of pieces of interactive media content associated with the preset video media content. Thus, a loss value of the to-be-trained model may be calculated based on an output result of the to-be-trained model and the labeled content. Any loss algorithm may be used to calculate the loss value of the to-be-trained model, which is not limited by the present disclosure.

Therefore, whether the to-be-trained model satisfies a preset convergence condition may be determined based on the loss value. The convergence condition may be that the loss value is less than a preset loss value threshold, or the convergence condition may be that a difference between loss values in two consecutive rounds of training is less than a preset difference threshold. As an implementable manner, the convergence condition may also be that the training duration reaches a preset duration threshold, the number of training rounds reaches a preset number threshold, etc., which is not limited by the present disclosure.

Further, if it is determined that the to-be-trained model satisfies the preset convergence condition, the current to-be-trained model may be determined as the target network model corresponding to the extended consumption intention. Otherwise, a parameter adjustment operation may be performed on the to-be-trained model based on the loss value. After the adjustment, the iterative training continues to be performed based on the third training dataset until the to-be-trained model satisfies the preset convergence condition, and the current to-be-trained model is determined as the target network model corresponding to the extended consumption intention.

According to the interactive content presentation method provided by this embodiment, different network models are trained in advance for different consumption intentions, so that after the current consumption intention is determined, an identification operation may be performed on all interactive content associated with the currently played multimedia content based on the target network model associated with the consumption intention, to implement the filtering operation of the target interactive content that matches the consumption intention. Therefore, the presented target interactive content is more in line with the user's consumption intention for the interactive media content.

In some embodiments, based on any of the above embodiments, the method further includes: acquiring a plurality of pieces of target interactive content corresponding to all pieces of multimedia content associated with the multimedia content set; determining a first cumulative number of the plurality of pieces of target interactive content corresponding to the all pieces of multimedia content; calculating proportion information of the first cumulative number in a second cumulative number of all interactive content associated with the multimedia content set; and determining content quality information of the multimedia content set based on the proportion information.

In this embodiment, for each piece of multimedia content in the multimedia content set, the filtering operation may be performed on all interactive content associated with the multimedia content based on the consumption intention associated with the multimedia content, to determine a plurality of pieces of target interactive content corresponding to the multimedia content.

Since the target interactive content is interactive content that is of high quality and more in line with the consumption intention in all the interactive content, the content quality information of the multimedia content set may be determined based on the number of pieces of target interactive content associated with all the multimedia content and the number of pieces of all interactive content associated with all the multimedia content.

In some embodiments, a plurality of pieces of target interactive content corresponding to all pieces of multimedia content associated with the multimedia content set are acquired. A first cumulative number of the plurality of pieces of target interactive content corresponding to all multimedia content is determined. The proportion information of the first cumulative number in a second cumulative number of all interactive content associated with the multimedia content set is calculated. The content quality information of the multimedia content set is determined based on the proportion information.

Thus, the recommendation operation of the multimedia content set may be performed based on the content quality. For example, if it is determined that the multimedia content set is of high quality, the recommendation intensity of the multimedia content set may be increased.

According to the interactive content presentation method provided by this embodiment, the proportion information is calculated according to the sum of relatively high-quality target interactive content corresponding to all the multimedia content and the sum of all interactive content corresponding to all the multimedia content, so that the content quality information of the multimedia content set may be accurately determined based on the proportion information. Thus, the recommendation operation of the multimedia content set may be performed based on the content quality information.

In some embodiments, based on any of the above embodiments, the method further includes: calculating, for each piece of multimedia content, proportion information between the plurality of pieces of target interactive content associated with the multimedia content and all interactive content associated with the multimedia content; determining video quality of the multimedia content based on the proportion information; and performing a content recommendation operation for the multimedia content based on the video quality.

In this embodiment, for each piece of multimedia content, its corresponding consumption intention may be determined based on its playback progress. Thus, the target interactive content that is of high quality and more in line with the consumption intention may be identified from all interactive content associated with the multimedia content based on the network model corresponding to the consumption intention.

Further, after the target interactive content associated with the multimedia content is determined, the video quality of the single-episode multimedia content may be determined based on the proportion of the target interactive content in all the interactive content. For example, if the proportion of high-quality interactive content is relatively high, it represents that the multimedia content is of high quality.

In some embodiments, for each piece of multimedia content, the number of pieces of associated target interactive content and the number of pieces of all associated interactive content may be determined, respectively. Therefore, the proportion information between the plurality of pieces of target interactive content associated with the multimedia content and all interactive media content associated with the multimedia content may be calculated. The video quality of the multimedia content is determined based on the proportion information. For example, a proportion threshold may be set in advance, and if the proportion information is greater than the proportion threshold, it is determined that the quality of the multimedia content is relatively high. Otherwise, it may be determined that the quality of the multimedia content is poor.

Thus, the content recommendation operation may be performed for the multimedia content based on the video quality.

For example, high-quality multimedia content in the multimedia content set may be recommended in a media content stream associated with the user. For example, if it is determined that the quality of the multimedia content is relatively high, when determining the media content stream associated with the user, the multimedia content may be added to the media content stream.

Alternatively, if it is determined that the content quality of the multimedia content is relatively high, the recommendation range of the multimedia content may be expanded, and the multimedia content may be recommended to more users.

According to the interactive content presentation method provided by this embodiment, the number proportion information between the target interactive content corresponding to a single piece of multimedia content and all interactive content is calculated, so that the video quality of the single piece of multimedia content may be accurately determined. Thus, the content recommendation operation of the single piece of multimedia content may be performed based on the video quality.

In some embodiments, based on any of the above embodiments, the method further includes: in response to determining that the multimedia content is last-episode media content in the multimedia content set, performing a semantic identification operation on all the interactive content associated with the multimedia content using a preset semantic network model; and determining content quality of an ending associated with the multimedia content based on a semantic identification result.

In this embodiment, for the last episode of multimedia content in the multimedia content set, the style monitoring may also be performed based on the interactive content associated with the multimedia content, to determine the content quality of the multimedia content set. For example, based on the semantic analysis of the interactive content, it may be determined whether the multimedia content set has a bad end, etc. Alternatively, based on the style monitoring, it may also be determined whether the ending of the multimedia content set is more in line with the user's expectations, etc.

In some embodiments, for each piece of multimedia content in the multimedia content set, whether it is the last-episode media content in the multimedia content set may be determined based on its associated playback progress such as the episode number. For example, the multimedia content set may include a 30-episode short drama, and if it is determined that the multimedia content is the 30th episode of multimedia content, it may be determined that it is the last-episode media content.

Further, for the last-episode media content, all associated interactive content may be acquired. The semantic identification operation is performed on all the interactive content associated with the multimedia content using the preset semantic network model. The content quality of the ending associated with the multimedia content set is determined based on the semantic identification result. For example, if, through the semantic analysis of all the interactive content, it is determined that there are a large number of words such as "bad end", "high start and low end", and "not good-looking" in the interactive content, it may be determined that the content quality of the multimedia content set is poor.

As an implementable manner, a plurality of target fields may also be set in advance, such as "bad end", "high start and low end", "not good-looking", "negative review", and "low score". After all the interactive content associated with the last-episode media content is acquired, it may be identified whether the above target field is included in all the interactive content. Thus, the content quality of the multimedia content set may be determined based on the number of target fields. For example, if the number of occurrences of the above target field in all the interactive media content exceeds a preset number threshold, it may be determined that the content quality of the multimedia content set is poor.

Thus, the recommendation operation of the multimedia content set may be performed based on the content quality. For example, if it is determined that the multimedia content set does not have a bad end and the user feedbacks that the multimedia content set is of high quality, the recommendation intensity of the multimedia content set may be increased. Alternatively, if it is determined that the multimedia content set has a sad ending, the recommendation operation may be performed for users who prefer tragedies.

According to the interactive content presentation method provided by this embodiment, the semantic identification is performed on the interactive content of the last-episode media content, so that content such as whether the multimedia content set has a bad end and the content quality of the multimedia content set may be accurately determined based on the semantic identification.

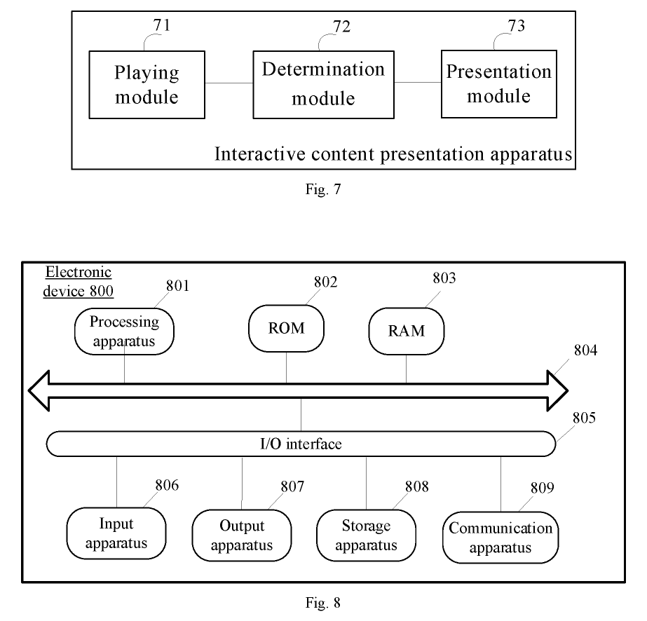

FIG. 7 is a schematic structural diagram of an interactive content presentation apparatus provided by an embodiment of the present disclosure. As shown in FIG. 7, the apparatus includes: a playing module 71, a determination module 72, and a presentation module 73. The playing module 71 is configured to play target media content. The determination module 72 is configured to determine a plurality of pieces of target interactive content from all interactive media content associated with the target media content, the target interactive content being configured to assist a user in performing a content consumption operation on the target media content, and the target interactive content being associated with a consumption intention of the user for the target media content. The presentation module 73 is configured to present the plurality of pieces of target interactive content.

Further, based on any of the above embodiments, the target media content is any piece of multimedia content in a preset multimedia content set, where a plurality of pieces of multimedia content in the multimedia content set have content continuity; and the user has different consumption intentions for multimedia content at different playback progress in the multimedia content set.

Further, based on any of the above embodiments, the target media content is preset video media content; and the user has different consumption intentions for presentation content at different playback progress in the video media content.

Further, based on any of the above embodiments, the determination module is configured to: determine a playback progress associated with the target media content; determine a target consumption intention of the user for the target media content based on the playback progress; and determine a plurality of pieces of target interactive content that match the target consumption intention from all the interactive media content associated with the target media content.

Further, based on any of the above embodiments, the determination module is configured to: determine a content recommendation intention for the multimedia content set as the target consumption intention in response to the playback progress being within a preset first progress interval; determine a plot discussion intention for the target media content as the target consumption intention in response to the playback progress being within a preset second progress interval; determine an intention to perform extended consumption based on the multimedia content set as the target consumption intention in response to the playback progress being within a preset third progress interval; where the third progress interval is greater than the second progress interval, and the second progress interval is greater than the first progress interval.

Further, based on any of the above embodiments, the determination module is further configured to: acquire first interactive media content associated with the target media content, the first interactive media content including interactive media content posted by a plurality of users historically for the target interactive content; determine historical recommendation content associated with the target media content, and determine second interactive media content associated with the target media content from all interactive media content associated with the historical recommendation content; and determine the plurality of pieces of target interactive content based on the first interactive media content and/or the second interactive media content.

Further, based on any of the above embodiments, the determination module is configured to determine a target network model associated with the target consumption intention; and input the first interactive media content and/or the second interactive media content into the target network model, and determine the plurality of pieces of target interactive content based on an output result of the target network model.

Further, based on any of the above embodiments, the target media content is any piece of multimedia content in a preset multimedia content set, and the determination module is configured to: determine plot content associated with the target media content; determine a plurality of pieces of multimedia content related to the plot content, the plurality of pieces of multimedia content including the target media content, and the plurality of pieces of multimedia content having content continuity; determine a plurality of pieces of interactive media content associated with the target media content from all interactive media content associated with the plurality of pieces of multimedia content; and determine the plurality of pieces of interactive media content associated with the target media content as the first interactive media content.

Further, based on any of the above embodiments, the determination module is configured to acquire the plurality of pieces of target interactive content associated with the target media content from a preset storage path; where the plurality of pieces of target interactive content are obtained by the server determining a target consumption intention corresponding to the target media content based on a playback progress associated with the target media content, and performing data processing on all interactive media content corresponding to the target media content using a target network model associated with the target consumption intention, and the plurality of pieces of target interactive content are stored into the storage path after a mapping relationship between the plurality of pieces of target interactive content and the target media content is established.

Further, based on any of the above embodiments, the apparatus further includes: an acquisition module configured to acquire interactive information associated with the target media content, the interactive information including one or more of: the number of pieces of interactive media content, the number of likes, and the number of plays; a processing module configured to determine interactive content to be presented that satisfies a preset presentation condition from all interactive media content associated with the target media content in response to the interactive information satisfying a preset content display condition; and a presentation module configured to present the interactive content to be presented in a preset presentation region of the media content presentation interface.

Further, based on any of the above embodiments, the determination module is configured to determine the plurality of pieces of target interactive content from all the interactive media content associated with the target media content in response to a trigger operation of the user on a preset interactive control in the media content presentation interface.

The device provided by this embodiment may be used to perform the technical solutions of the above method embodiments, and the implementation principles and technical effects thereof are similar, which will not be repeated here in this embodiment.

In order to achieve the above embodiments, an embodiment of the present disclosure further provides a computer-readable storage medium, where the computer-readable storage medium stores a computer-executable instruction, and when a processor executes the computer-executable instruction, the interactive content presentation method according to any of the above embodiments is implemented.

In order to achieve the above embodiments, an embodiment of the present disclosure further provides a computer program product, including a computer program, where when the computer program is executed by a processor, the interactive content presentation method according to any of the above embodiments is implemented.

In order to achieve the above embodiments, an embodiment of the present disclosure further provides an electronic device, including: a processor and a memory; where the memory stores a computer-executable instruction; and the processor executes the computer-executable instruction stored in the memory, to cause the processor to execute the interactive content presentation method according to any of the above embodiments.

FIG. 8 is a schematic structural diagram of an electronic device provided by an embodiment of the present disclosure, and the electronic device 800 may be a terminal device or a server. The terminal device may include, but is not limited to, mobile terminals such as a mobile phone, a notebook computer, a digital broadcast receiver, a personal digital assistant (PDA), a tablet computer, a portable media player (PMP), and a vehicle-mounted terminal (e.g., a vehicle-mounted navigation terminal), and fixed terminals such as a digital TV and a desktop computer. The electronic device shown in FIG. 8 is only an example, and should not impose any limitation on the function and scope of use of the embodiments of the present disclosure.

As shown in FIG. 8, the electronic device 800 may include a processing apparatus (e.g., a central processing unit, a graphics processor, etc.) 801, which may perform various appropriate actions and processing according to a program stored in a read-only memory (ROM) 802 or a program loaded from a storage apparatus 808 into a random access memory (RAM) 803. The RAM 803 further stores various programs and data required for the operation of the electronic device 800. The processing apparatus 801, the ROM 802, and the RAM 803 are connected to each other through a bus 804. An input/output (I/O) interface 805 is also connected to the bus 804.

Usually, the following apparatuses may be connected to the I/O interface 805: an input apparatus 806 including, for example, a touch screen, a touchpad, a keyboard, a mouse, a camera, a microphone, an accelerometer, and a gyroscope; an output apparatus 807 including, for example, a liquid crystal display (LCD), a speaker, and a vibrator; a storage apparatus 808 including, for example, a magnetic tape and a hard disk; and a communication apparatus 809. The communication apparatus 809 may allow the electronic device 800 to perform wireless or wired communication with other devices to exchange data. Although FIG. 8 shows the electronic device 800 with various apparatuses, it should be understood that it is not required to implement or have all the apparatuses shown. More or fewer apparatuses may be implemented or provided alternatively.

In particular, according to an embodiment of the present disclosure, the process described above with reference to the flowchart may be implemented as a computer software program. For example, an embodiment of the present disclosure includes a computer program product, which includes a computer program carried on a computer-readable medium, where the computer program includes program code for performing the method shown in the flowchart. In such an embodiment, the computer program may be downloaded and installed from a network via the communication apparatus 809, or installed from the storage apparatus 808, or installed from the ROM 802. When the computer program is executed by the processing apparatus 801, the above-mentioned functions defined in the method of the embodiments of the present disclosure are executed.

It should be noted that the above-mentioned computer-readable medium in the present disclosure may be a computer-readable signal medium, a computer-readable storage medium, or any combination thereof. The computer-readable storage medium may be, for example, but is not limited to, an electrical, magnetic, optical, electromagnetic, infrared, or semiconductor system, apparatus, or device, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program, and the program may be used by or in combination with an instruction execution system, apparatus, or device. In the present disclosure, the computer-readable signal medium may include a data signal propagated on a baseband or as a part of a carrier, and computer-readable program code is carried in the data signal. The data signal propagated in this way may be in multiple forms, including but not limited to an electromagnetic signal, an optical signal, or any suitable combination thereof. The computer-readable signal medium may also be any computer-readable medium other than the computer-readable storage medium, and the computer-readable signal medium may send, propagate, or transmit the program used by or in combination with the instruction execution system, apparatus, or device. The program code contained on the computer-readable medium may be transmitted in any suitable medium, including but not limited to: a wire, an optical cable, a radio frequency (RF), etc., or any suitable combination thereof.

The above-mentioned computer-readable medium may be contained in the above-mentioned electronic device, or may exist alone without being assembled into the electronic device.

The above-mentioned computer-readable medium carries one or more programs, and when the above-mentioned one or more programs are executed by the electronic device, the electronic device is caused to execute the method shown in the above-mentioned embodiments.

The computer program code for performing the operations of the present disclosure may be written in one or more programming languages or a combination thereof, where the above-mentioned programming languages include object-oriented programming languages such as Java, Smalltalk, or C++, and also include conventional procedural programming languages such as "C" language or similar programming languages. The program code may be executed entirely on a user computer, partly on the user computer, as a stand-alone software package, partly on the user computer and partly on a remote computer, or entirely on the remote computer or a server. In the case involving the remote computer, the remote computer may be connected to the user computer through any kind of network, including a local area network (LAN) or a wide area network (WAN), or it may be connected to an external computer (for example, connected by using Internet provided by an Internet service provider).

The flowchart and block diagrams in the drawings illustrate the architecture, functionality, and operation of possible implementations of the systems, methods and computer program products according to various embodiments of the present disclosure. In this regard, each block in the flowchart or block diagrams may represent a module, a program segment, or a portion of code that includes one or more executable instructions for implementing a specified logical function. Furthermore, it should be noted that, in some alternative implementations, functions indicated in the blocks may occur in an order different from that indicated in the drawings. For example, two blocks shown in succession may, in fact, be executed substantially in parallel, or the blocks may sometimes be executed in a reverse order, depending upon the functionality involved. It also should be noted that each block of the block diagrams and/or flowcharts, or a combination of blocks in the block diagrams and/or flowcharts may be implemented in a special purpose hardware-based system that perform a specified function or operation, or may be implemented in a combination of special purpose hardware and a computer instruction.

The units involved in the embodiments of the present disclosure may be implemented by means of software, and may also be implemented by means of hardware. The name of a unit does not constitute a limitation on the unit itself under certain circumstances, for example, a first acquisition unit may also be described as "a unit for acquiring at least two internet protocol addresses". The functions described herein above may be performed, at least in part, by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD) and more.

In the context of the present disclosure, a machine-readable medium may be a tangible medium that may contain or store a program for use by or in combination with an instruction execution system, apparatus or device. The machine-readable medium may be a machine-readable signal medium or a machine-readable storage medium. The machine-readable medium includes, but is not limited to, an electronic, magnetic, optical, electromagnetic, infrared, or semi-conductive system, apparatus or device, or any suitable combination of the above. More specific examples of the machine-readable storage medium would include an electrical connection on the basis of one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

The above description illustrates merely preferred embodiments of the present disclosure and an explanation of the applied technical principles. Those skilled in the art should understand that the scope of disclosure involved in the present disclosure is not limited to the technical solutions formed by the specific combinations of the above technical features, and shall also cover other technical solutions formed by any combination of the above technical features or equivalent features thereof without departing from the above disclosed concept, for example, a technical solution formed by a replacement of the above features with technical features with similar functions disclosed in the present disclosure (but not limited thereto).

Furthermore, although operations are depicted in a particular order, this should not be construed as requiring that such operations should be performed in a specific order as illustrated or in a sequential order. Under specific circumstances, multitasking and parallel processing may be advantageous. Likewise, although several specific implementation details are included in the above discussions, these should not be construed as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in a language specific to structural features and/or logical actions of the method, it should be understood that the subject matter defined in the appended claims is not necessarily limited to the specific features or actions described above. Conversely, the specific features and actions described above are merely exemplary forms for implementing the claims.

What is claimed is:

1. An interactive content presentation method, comprising:
playing target media content;
determining a plurality of pieces of target interactive content from all interactive media content associated with the target media content, wherein the target interactive content is configured to assist a user in performing a content consumption operation on the target media content, and the target interactive content is associated with a consumption intention of the user for the target media content; and
presenting the plurality of pieces of target interactive content.

2. The interactive content presentation method according to claim 1, wherein the target media content is any piece of multimedia content in a preset multimedia content set, wherein a plurality of pieces of multimedia content in the multimedia content set have content continuity; and
the user has different consumption intentions for multimedia content at different playback progress in the multimedia content set.

3. The interactive content presentation method according to claim 1, wherein the target media content is preset video media content, and the user has different consumption intentions for presentation content at different playback progress in the video media content.

4. The interactive content presentation method according to claim 1, wherein the determining the plurality of pieces of target interactive content from all the interactive media content associated with the target media content comprises:
determining a playback progress associated with the target media content;
determining a target consumption intention of the user for the target media content based on the playback progress; and
determining the plurality of pieces of target interactive content that match the target consumption intention from all the interactive media content associated with the target media content.

5. The interactive content presentation method according to claim 4, wherein the determining the target consumption intention of the user for the target media content based on the playback progress comprises:
determining a content recommendation intention for a multimedia content set as the target consumption intention in response to the playback progress being within a preset first progress interval;
determining a plot discussion intention for the target media content as the target consumption intention in response to the playback progress being within a preset second progress interval; and
determining an intention to perform extended consumption based on the multimedia content set as the target consumption intention in response to the playback progress being within a preset third progress interval,
wherein the third progress interval is greater than the second progress interval, and the second progress interval is greater than the first progress interval.

6. The interactive content presentation method according to claim 4, wherein the determining the plurality of pieces of target interactive content that match the target consumption intention from all the interactive media content associated with the target media content comprises:
acquiring first interactive media content associated with the target media content, wherein the first interactive media content comprises interactive media content posted by a plurality of users historically for the target interactive content;
determining historical recommendation content associated with the target media content, and determining second interactive media content associated with the target media content from all interactive media content associated with the historical recommendation content; and
determining the plurality of pieces of target interactive content based on the first interactive media content and/or the second interactive media content.

7. The interactive content presentation method according to claim 6, wherein the determining the plurality of pieces of target interactive content based on the first interactive media content and/or the second interactive media content comprises:
determining a target network model associated with the target consumption intention; and
inputting the first interactive media content and/or the second interactive media content into the target network model, and determining the plurality of pieces of target interactive content based on an output result of the target network model.

8. The interactive content presentation method according to claim 6, wherein the target media content is any piece of multimedia content in a preset multimedia content set, and the acquiring the first interactive media content associated with the target media content comprises:
determining plot content associated with the target media content;
determining a plurality of pieces of multimedia content related to the plot content, wherein the plurality of pieces of multimedia content comprise the target media content, and the plurality of pieces of multimedia content have content continuity;
determining a plurality of pieces of interactive media content associated with the target media content from all interactive media content associated with the plurality of pieces of multimedia content; and
determining the plurality of pieces of interactive media content associated with the target media content as the first interactive media content.

9. The interactive content presentation method according to claim 1, wherein the determining the plurality of pieces of target interactive content from all the interactive media content associated with the target media content comprises:
acquiring the plurality of pieces of target interactive content associated with the target media content from a preset storage path,
wherein the plurality of pieces of target interactive content are obtained by a server determining a target consumption intention corresponding to the target media content based on a playback progress associated with the target media content, and performing data processing on all interactive media content corresponding to the target media content using a target network model associated with the target consumption intention, and the plurality of pieces of target interactive content are stored into the storage path after a mapping relationship between the plurality of pieces of target interactive content and the target media content is established.

10. The interactive content presentation method according to claim 1, further comprising:
acquiring interactive information associated with the target media content, wherein the interactive information comprises one or more of: a number of pieces of interactive media content, a number of likes, and a number of plays;
determining interactive content to be presented that satisfies a preset presentation condition from all interactive media content associated with the target media content in response to the interactive information satisfying a preset content display condition; and
presenting the interactive content to be presented in a preset presentation region of a media content presentation interface.

11. The interactive content presentation method according to claim 1, wherein the determining the plurality of pieces of target interactive content from all the interactive media content associated with the target media content comprises:
determining the plurality of pieces of target interactive content from all the interactive media content associated with the target media content in response to a trigger operation of the user on a preset interactive control in a media content presentation interface.

12. An electronic device, comprising: a processor and a memory;
wherein the memory stores a computer-executable instruction; and
the processor executes the computer-executable instruction stored in the memory, to cause the processor to:
play target media content;
determine a plurality of pieces of target interactive content from all interactive media content associated with the target media content, wherein the target interactive content is configured to assist a user in performing a content consumption operation on the target media content, and the target interactive content is associated with a consumption intention of the user for the target media content; and
present the plurality of pieces of target interactive content.

13. The electronic device according to claim 12, wherein the target media content is any piece of multimedia content in a preset multimedia content set, wherein a plurality of pieces of multimedia content in the multimedia content set have content continuity; and
the user has different consumption intentions for multimedia content at different playback progress in the multimedia content set.

14. The electronic device according to claim 12, wherein the target media content is preset video media content, and the user has different consumption intentions for presentation content at different playback progress in the video media content.

15. The electronic device according to claim 12, wherein the processor executes the computer-executable instruction stored in the memory, to cause the processor to:
determine a playback progress associated with the target media content;
determine a target consumption intention of the user for the target media content based on the playback progress; and
determine the plurality of pieces of target interactive content that match the target consumption intention from all the interactive media content associated with the target media content.

16. The electronic device according to claim 15, wherein the processor executes the computer-executable instruction stored in the memory, to cause the processor to:
determine a content recommendation intention for a multimedia content set as the target consumption intention in response to the playback progress being within a preset first progress interval;
determine a plot discussion intention for the target media content as the target consumption intention in response to the playback progress being within a preset second progress interval; and
determine an intention to perform extended consumption based on the multimedia content set as the target consumption intention in response to the playback progress being within a preset third progress interval,
wherein the third progress interval is greater than the second progress interval, and the second progress interval is greater than the first progress interval.

17. A non-transitory computer-readable storage medium, wherein the non-transitory computer-readable storage medium stores a computer-executable instruction, and the computer-executable instruction, when executed by a processor, cause the processor to:
play target media content;
determine a plurality of pieces of target interactive content from all interactive media content associated with the target media content, wherein the target interactive content is configured to assist a user in performing a content consumption operation on the target media content, and the target interactive content is associated with a consumption intention of the user for the target media content; and
present the plurality of pieces of target interactive content.

18. The non-transitory computer-readable storage medium according to claim 17, wherein the target media content is any piece of multimedia content in a preset multimedia content set, wherein a plurality of pieces of multimedia content in the multimedia content set have content continuity; and
the user has different consumption intentions for multimedia content at different playback progress in the multimedia content set.

19. The non-transitory computer-readable storage medium according to claim 17, wherein the target media content is preset video media content, and the user has different consumption intentions for presentation content at different playback progress in the video media content.

20. The non-transitory computer-readable storage medium according to claim 17, wherein the computer-executable instruction, when executed by the processor, cause the processor to:
determine a playback progress associated with the target media content;
determine a target consumption intention of the user for the target media content based on the playback progress; and
determine the plurality of pieces of target interactive content that match the target consumption intention from all the interactive media content associated with the target media content.
